(19) United States
(12) Patent Application Publication
(10) Pub. No.: US 2008/0192795 A1
(43) Pub. Date: Aug. 14, 2008

(54) Electric Insulation for the Lid of an Electric Arc Furnace

(75) Inventors: Tom Ronnberg, Espoo (FI); Janne Ollila, Espoo (FI)

Correspondence Address: SMITH-HILL AND BEDELL, P.C., 16100 NW CORNELL ROAD, SUITE 220, BEAVERTON, OR, 97006, US

(73) Assignee: OUTOTEC OYJ, Espoo (FI)

(21) Appl. No.: 11/910,461

(22) PCT Filed: Apr. 25, 2006
(86) PCT No.: PCT/FI2006/000134

§ 371 Date: Oct. 2, 2007

(30) Foreign Application Priority Data
Apr. 29, 2005 (FI) 20050460

(51) Int. Cl. F27D 11/10; H05B 7/12

(52) U.S. Cl. 373/71; 373/94

(57) ABSTRACT

The invention is an electric insulation system for a steel-structured lid of an electric arc furnace, where the electrode lead-throughs are provided with electric insulation for preventing breakdowns, and the lid is sealed from the furnace vessel by means of a sand seal. The lid is divided by steel-structured panels to at least six mutually electrically insulated segments, three of which form the lid center part, so that each center part segment outlines one lead-through of an electrode, and at least three of which form the outer perimeter of the lid.

The present invention relates to the structure of an arc furnace used in metallurgy. More precisely, the invention relates to the electric insulation of the lid of an electric furnace, particularly a closed arc furnace.

An electric furnace used in metallurgic processes, for instance in the manufacturing of ferrochromium, is composed of a vessel and a lid, as well as electrodes lead through the lid. The lid is provided with lead-throughs for three generally Söderberg-type electrodes, and apertures for gas outlet and raw material feed. It is important that the electrodes are electrically insulated from the lid for preventing breakdowns and for securing safety at work. Electric insulation is particularly important in cases where the structure of the lid, i.e. the vault, is mainly made of steel and thus represents electroconductive material. The lid is arranged to extend as far as the vessel edges, and generally the lid also is insulated both from the vessel and the ground. Moreover, both the electrode lead-throughs and the junction between the vessel and the lid must be gas-tight for conducting process gases out of the furnace in a controlled way. Usually the lid sealing and the electric insulation from the vessel are realized by means of a so-called sand seal, where the gap between the lid and the top edge of the vessel wall is filled with sand.

The Finnish patent publication 81,197 suggests a solution for sealing the electrodes of an electric furnace and for insulating them from the lid. Said publication introduces a solution for fitting the electrode and for insulating it from the vault, so that around the electrode, there are arranged contact shoes and a pressure ring, and from the vault upwards, around the electrode structure, there is placed a closed lead-through basin with several segments, which basin is cooled by means of water circulation. The lead-through basin is insulated from the vault by means of a protective mass layer that is formed on the vault side, between the vault and the lead-through vessel. Above the lead-through basin, there are arranged two superimposed sealing segments that ensure a reliable and flexible sealing structure and make it possible to move the electrodes back and forth in the vertical direction.

For ensuring a non-disturbed operation for the process, and for improving safety at work, there is a need to find extremely secure electric insulation solutions for steel-structured lids. The object of the present invention is to create a reliable electric insulation system for electrodes in the lid of a steel-structured arc furnace. The now developed electric arc furnace lid and the advanced electrode lead-through eliminate some of the drawbacks connected to the prior art and result in an extremely reliable, safe and easily maintained lid solution.

In regular steel-structured lids of arc furnaces, the lining arranged underneath the lid generally extends as uniform lining over the whole area of the lid. When the lid needs partial maintenance, for example when replacing the lead-throughs, the interior lining of the lid must be repaired, and easily the whole lining must be replaced. This naturally extends the interruption of the productive process and thus causes extra expenses.

Thus it is advantageous to construct the lid for an arc furnace of at least three panels that are bolted together. This kind of solution enables a rapid and flexible maintenance for damaged parts of the lid, so that the whole lid with linings need not be replaced.

The electric arc furnace lid according to the invention is a water-cooled structure made of steel, where an essential element is a water-cooled and electrically insulated lead-through casing for electrodes. The lid can be a self-bearing structure realized so that the steel structure forms a double casing, and in between said casing there is formed a box-like channel system for the cooling water circulation. The cooling-water channel is outlined by the casings of the top and bottom part of the lid, as well as essentially vertical partition walls arranged between said casings. The underneath surface of the steel lid is provided with refractory lining that is in contact with the steel structure. The lid can also be provided with steel anchors for supporting the lining against the lid.

The arc furnace lid according to the invention comprises at least six electrically insulated segments that are bolted together, three of which segments form the lid center part, so that each segment of the center part outlines one electrode lead-through, as well as at least three segments constituting the outer perimeter, said segments being electrically insulated from each other and from the center part segments. Moreover, there can be provided at least one center segment that mutually separates the three center part segments. There is thus created a lid insulation system for ensuring that electrodes electrically connected to the different process steps cannot be interconnected through the lid, and that the electrodes are insulated from the vessel in a triple form. Said insulations constitute insulations arranged in the electrode lead-throughs, lid segment insulations conforming to the perimeter, radial insulations between the segments and a sand seal arranged between the lid and the vessel. The radial segment insulations outline a uniform segment, inside which one electrode is left.

The segments of the lid can be constructed of one or several mutually attached panels. The essential thing is that the lid is divided by panels to the above described, mutually insulated at least six segments.

The invention is described in more detail below, with reference to the appended drawings.

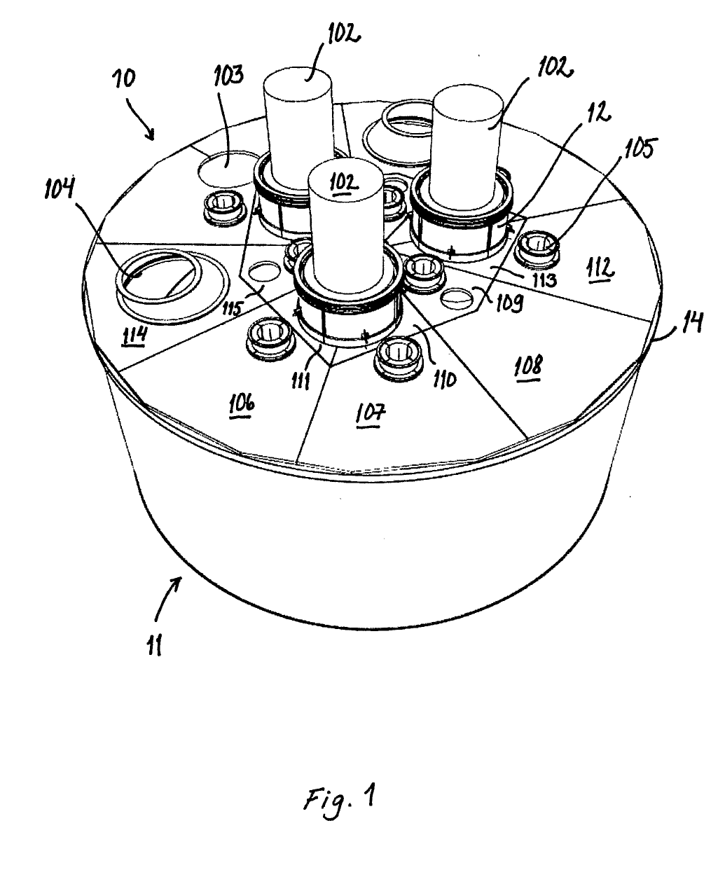

FIG. 1 illustrates a lid according to the invention, fitted on top of the vessel of an electric arc furnace.

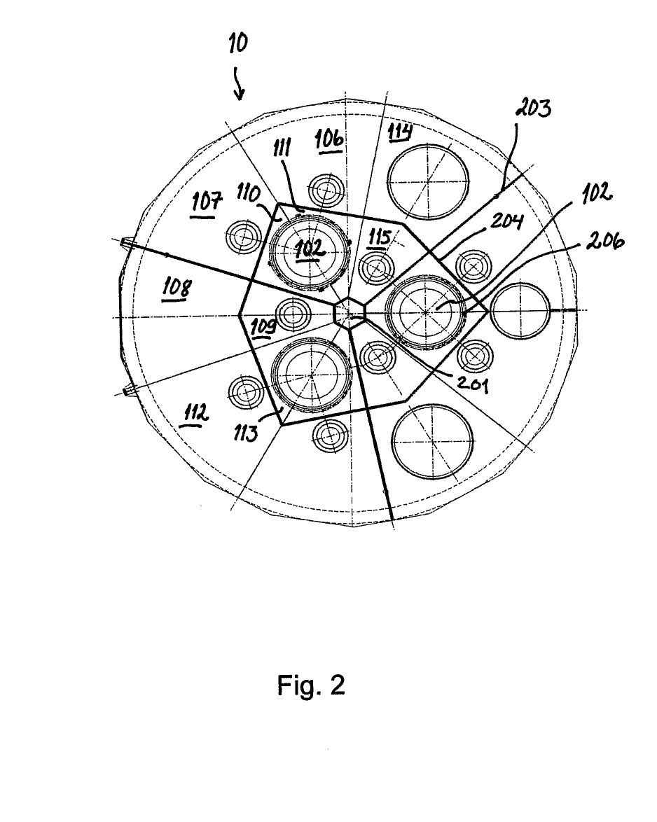

FIG. 2 illustrates the lid of FIG. 1 as seen from above.

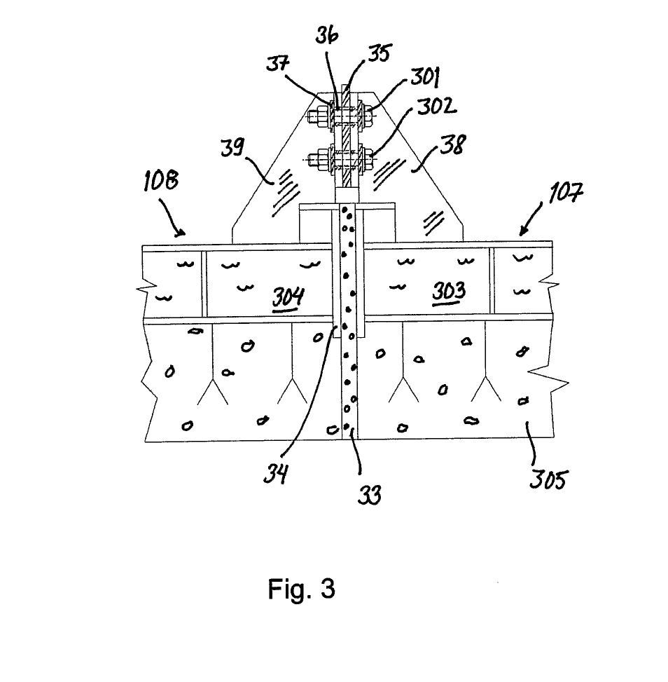

FIG. 3 represents a cross-sectional view showing the together-bolted panels of the lid according to the invention and of the electric insulation provided at the junction of the panels.

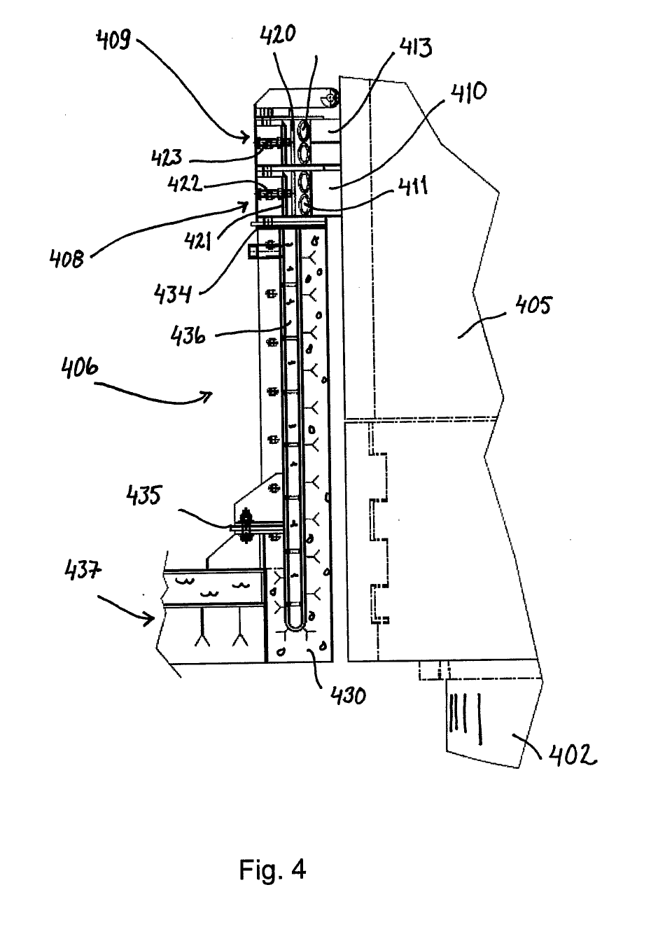

FIG. 4 is a cross-sectional view showing the electrode lead-through of the electric arc furnace.

FIG. 1 shows the lid 10 and vessel 11 of the arc furnace. Electrodes 102 are lead through the lid 10, and the lead-throughs 12 are gas-tight and water-cooled. The sand seal 14 arranged between the lid 10 and the vessel 11 passes in a ring between the vessel edge and the lid. The lid is provided with gas outlet apertures 102, 104, apertures 105 for raw material feed and an inspection door 106 that can also serve as a material feed aperture. The steel-structured lid is composed of several panels 13, 15. In the embodiment illustrated in FIG. 1, the number of center part panels 109, 110, 111, 113, 115 is nine, and they are arranged in radial segments. The center part panels outline the electrode lead-throughs and part of the raw material feed apertures 105, 106. The outer perimeter zone of the lid is formed by nine panels 106, 107, 108, 112, 114 arranged in a circle. All panels are attached to the adjacent panel by bolting.

In FIG. 2, the electric insulations 204, 203 between the junctions of the panels of the lid 10 are marked with a thicker line. For instance the panels 110, 111 and 115 form a segment of the lead-through for the electrode 102 that is electrically insulated from other segments. For instance the panels 107, 106 and 114 form an outer perimeter segment that is electrically insulated from the adjacent segments, as well as from the furnace vessel by the sand seal 14. Moreover, the embodiment illustrated in FIG. 2 also comprises a center panel 201 that is likewise insulated from the adjacent panels. Each electrode lead-through comprises an insulation 206 that insulates the electrode from the lid 10.

FIG. 3 shows a junction between two adjacent panels 108, 107 and the insulation provided at the junction, depicted by numbers 203, 204 in FIG. 2. Support plates 38, 39 connect the panels 108, 107 together by means of bolts 301, 302. The panels are mutually separated by ceramic, electrically insulating wool 33. FIG. 3 illustrates the water circulation channels 303, 304 of the panels. The lower steel casing of the panels is provided with a protective mass layer 305 underneath the lid. The mass layers 305 and the end flanges 34 of the panels press the wool layer 33 in place. The bolt joints are provided with insulating sleeves 306, insulating washers 37 and an insulating plate 35 to ensure a good electric insulation between the panels.

FIG. 4 illustrates a lead-through of a Söderberg-type electrode 402. Important elements connected to the electrode are a water-cooled protective hood 405 and a contact shoe, both shown in the drawing. The lead-through according to the invention comprises a cylindrical, multi-segment lead-through casing 406, formed of a steel double casing structure, so that in between the casings there is arranged a cooling-water channel 436. On the electrode-side outer surface of the double casing structure, there is provided an electroconductive mass layer 430. In the double casing structure, there are attached anchors for fastening the electrically insulating mass layer 430 to the lead-through casing 406. Above the lead-through flange, there are installed two superimposed sealing segments 408, 409. The lower sealing segment 408 comprises a graphite ring 410 that is pressed against the structure of the electrode 405. The graphite ring is tightened against the electrode by a hydraulic press 411. The upper sealing segment 409 comprises a cord sealing 413 which also is tightened against the electrode by a hydraulic press 414. In a preferred embodiment according to the invention, the hydraulic presses are liquid-filled hoses that are pretightened to initial tension by tightening plates 420, 421 prior to pressurizing the hoses 410, 414. Advantageously the tightening plates 420, 421 are curved objects that conform to the curved outer surface of the electrode. The tightening plates 420, 421 are tightened by tightening elements, such as adjusting bolts or springs 422, 423 against the hoses 413, 414 in order to create pretension. This novel pretensioning arrangement makes the installation of the electrodes remarkably easier, because in the arrangement according to the invention, the hydraulic presses can be released sufficiently and easily in connection with the replacing of an electrode.

The steel double casing structure of the lead-through casing 406 is insulated from the sealing segment 408 by an insulation layer 434, which is arranged between the flange of the top surface of the double casing structure and the sealing segment 408. The lead-through casing 406 is insulated from the furnace lid, i.e. from the vault 437 by an insulation 435 provided between the flanges.

1-8. (canceled)

9. An electric insulation system for electrodes of an electric arc furnace, where the electrode lead-throughs are provided with electric insulation for preventing breakdowns, and the lid of the electric arc furnace is sealed from the furnace vessel by means of a sand seal, wherein the lid is divided by steel-structured panels to at least six mutually electrically insulated segments, three of which form the lid center part, so that each center part segment outlines one lead-through of an electrode, and at least three of which form the outer perimeter of the lid, and that the the lead-through comprises a cylindrical, multi-segment lead-through casing, formed of a double casing steel structure, between the casings whereof there is arranged a cooling-water channel, and the outer surface of the double casing structure is on the electrode side covered by an electrically insulating mass layer.

10. An insulation system according to claim 9, wherein the lid segments are constructed of more than one panels that are bolted together.

11. An insulation system according to claim 9, wherein the number of the center part panels is nine, and the panels are arranged in radial segments.

12. An insulation system according to claim 9, wherein the outer perimeter of the lid is formed by nine panels arranged in a circle.

13. An insulation system according to claim 9, wherein the steel double casing structure of the lead-through casing of the lead-through is insulated from the sealing segment by an insulation layer arranged between the top surface flange of the double casing structure and the sealing segment, and that the lead-through casing is insulated from the furnace lid, i.e. vault, by insulation provided in between the flanges.

14. An insulation system according to claim 9, wherein above the lead-through flange of the lead-through, there are installed two superimposed sealing segments and that the lower sealing segment comprises a graphite ring that is pressed against the electrode structure, which graphite ring is tightened against the electrode by a hydraulic press, and that the upper sealing segment comprises a cord sealing that is tightened against the electrode by a hydraulic press, and that the hydraulic presses are pretightened by pretensioning tightening plates to initial tension prior to pressurizing the hoses.

15. An insulation system according to claim 14, wherein the tightening plates are curved objects that conform to the curved outer surface of the electrode structure.

16. An insulation system according to claim 14, wherein the tightening plates are tightened by means of adjusting elements against the hoses in order to create pretension.
